(19) United States
(12) Patent Application Publication
(10) Pub. No.: US 2015/0052578 A1
(43) Pub. Date: Feb. 19, 2015

(54) WIRELESS CONFIGURATION AND MANAGEMENT OF A SECURITY SYSTEM

(71) Applicants: Herman Yau, Palo Alto, CA (US); Ronald G. Pace, Naperville, IL (US)

(72) Inventors: Herman Yau, Palo Alto, CA (US); Ronald G. Pace, Naperville, IL (US)

(21) Appl. No.: 13/965,192

(22) Filed: Aug. 13, 2013

(51) Int. Cl. G06F 21/62; H04W 12/00

(52) U.S. Cl. CPC G06F 21/6218; H04W 12/00
USPC 726/3

(57) ABSTRACT

A computer implemented method and system for configuring and managing a security system wirelessly is provided. The security system includes a gateway device and a wireless access point (WAP) for communicating with one or more electronic devices and monitoring event data from the electronic devices. The electronic devices connect to the gateway device via the WAP in the gateway device. A wireless router is connected to the security system to establish a network. A security management application on a control device accesses, configures, and controls the security system wirelessly through the WAP. The security system receives and transmits event data through the WAP to a database, the control device, and/or one or more secondary devices via the network. The security management application wirelessly configures and manages the security system and one or more electronic devices through the WAP via the network based on the received event data.

### BACKGROUND

Setting up a security system for a home or a business is typically cumbersome and tedious. Most often, setting up the security system requires specific technical knowledge and/or tools, which prevent the fast adoption of a security system into a home or a business entity for surveillance applications. Hardware installation and setup are required to have a properly functioning security system. Hardware installation and setup is typically performed by a professional person with specific tools. A conventional security surveillance system using an internet protocol (IP) enabled camera and an internet gateway simplifies hardware installation by using wireless technology such as Wi-Fi® of the Wireless Ethernet Compatibility Alliance, Inc. However, the conventional security surveillance system does not resolve the complicated system set up work involved due to the extra set up procedure required for Wi-Fi®. Most often, a personal computer (PC) with an agent residing on a control platform is typically used to ease such a complicated set up procedure. The entire security system is therefore becoming a PC based operation instead of a standalone system based operation.

Conventional security systems, for example, surveillance devices require port forwarding and dynamic domain name system (DNS) configuration which have confusing configuration settings. Extra software and equipment are needed for installing these security systems. Conventional security cameras, typically protected by a single username and password, do not have an internal firewall and are exposed to the public domain, thereby allowing unauthorized events to frequently occur. Moreover, these security systems are not accessible by different devices with different browser applications or interfaces.

Hence, there is a long felt but unresolved need for a computer implemented method and system that enables configuration and management of a security system wirelessly without requiring specific technical knowledge or additional tools to set up the security system. Moreover, there is a need for a computer implemented method and system that does not expose the security system to the public domain and that provides secure access of the security system to electronic devices with different browser applications and interfaces. Furthermore, there is a need for a computer implemented method and system that prevents unauthorized devices from accessing and controlling the security system.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above mentioned needs for enabling configuration and management of a security system wirelessly, without requiring specific technical knowledge or additional tools to set up the security system. The computer implemented method and system disclosed herein does not expose the security system to the public domain and provides secure access of the security system to electronic devices with different browser applications and interfaces. Furthermore, the computer implemented method and system prevents unauthorized devices from accessing and controlling the security system. The computer implemented method and system disclosed herein enables configuration and management of a security system wirelessly by incorporating a wireless access point, for example, a Wi-Fi® enabled access point into a gateway device and a method to set up the security system by connecting a control device, for example, a mobile phone or a network enabled device directly to the gateway device via the wireless access point.

The computer implemented method and system disclosed herein provides a security system comprising at least one processor configured to enable the configuration and the management of the security system wirelessly. The security system further comprises a gateway device and a wireless access point configured to communicate with one or more of multiple electronic devices, for example, wired or wireless sensors, tracking devices, etc., and to monitor event data from one or more of the electronic devices. As used herein, the term “gateway device” refers to a device configured to operably couple to a network, for example, the internet, and also to couple wirelessly through the wireless access point to one or more electronic devices. The gateway device is configurable with one or more application programs to monitor and/or control one or more electronic devices via the wireless access point. The gateway device is configured, for example, as a box, an alarm panel, or a separate internet gateway. Also, as used herein, the term “wireless access point” refers to a device that allows wireless electronic devices to connect to a network, for example, using Wi-Fi® of the Wireless Ethernet Compatibility Alliance, Inc. The wireless access point is incorporated in the gateway device. The electronic devices connect to the gateway device of the security system via the wireless access point. A wireless router is operably connected to the security system to establish a network, for example, a wireless network.

Furthermore, the computer implemented method and system disclosed herein provides a security management application executable by at least one processor on a user's control device. The security management application is configured to access, configure, and control the security system and one or more electronic devices wirelessly through the wireless access point of the security system. The security system receives event data on one or more events from one or more electronic devices through the wireless access point. As used herein, the term “event data” refers to computer readable data, for example, audiovisual data, snapshot data, video data, image data, data indicative of motion, etc., associated with events performed by an electronic device and/or an authorized user or an unauthorized user, for example, based on an action, a characteristic, a condition or a state, a state change, behavior, performance, etc., of the electronic device and/or the authorized user or the unauthorized user. The security system transmits the received event data to a database, the control device, and/or one or more secondary devices via the network. The security management application on the control device wirelessly configures and manages the security system and one or more electronic devices through the wireless access point via the network based on the received event data.

In an embodiment, the security system detects an unauthorized event performed by an unauthorized electronic device and/or an unauthorized user using the received event data. As used herein, the term “unauthorized event” refers to any unauthorized intrusion into a premises, for example, a house, a shop, a building, etc., or a network path by an unauthorized user. The unauthorized event may also refer to any unauthorized intrusion by an unauthorized device attempting to access and control the security system. The security system generates an alert on detection of the unauthorized event. The security system generates an alert and transmits an alert message to the security management application on the control device via the network, when one or more of the electronic devices detect the unauthorized event. In another embodiment, the security system transmits one or more notifications on status and actions triggered in the security system to the security management application on the control device via the network.

In an embodiment, the security management application on the control device provides a graphical user interface (GUI) for receiving selections of one or more of the electronic devices, definitions of security profiles and zones, and user inputs from the control device for the configuration and the management of the security system and one or more of the electronic devices. In an embodiment, the security management application on the control device activates or deactivates the security system through the wireless access point. In another embodiment, the security management application on the control device changes security settings of the security system through the wireless access point.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for configuring and managing a security system wirelessly.

FIG. 2 illustrates a computer implemented system for configuring and managing a security system wirelessly.

FIG. 3 exemplarily illustrates an architecture of a computer system employed by the security system and a security management application for configuring and managing a security system wirelessly.

FIG. 4 exemplarily illustrates an implementation of the security system.

FIGS. 5A-5C exemplarily illustrate screenshots of a graphical user interface provided by the security management application for configuring and managing the security system wirelessly.

### DETAILED DESCRIPTION OF THE INVENTION

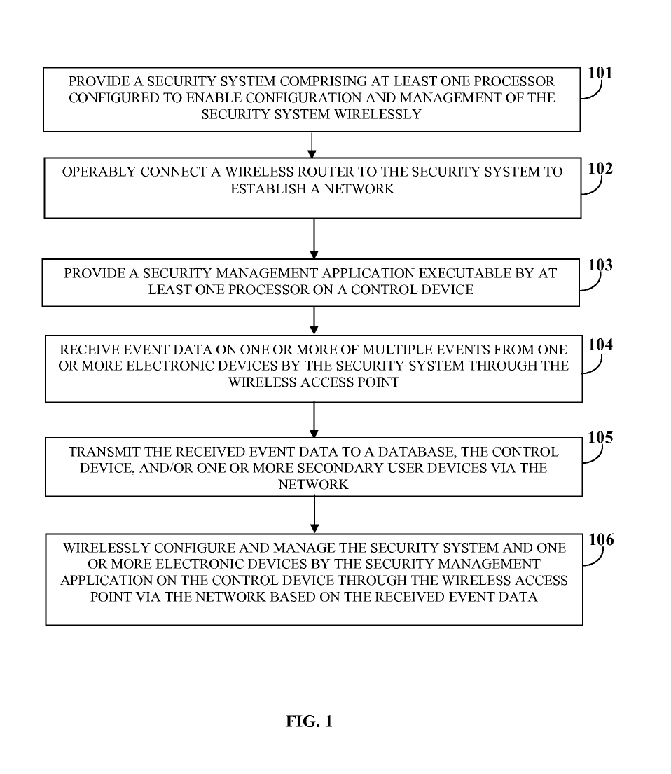

FIG. 1 illustrates a computer implemented method for configuring and managing a security system wirelessly. The computer implemented method provides 101 a security system comprising at least one processor configured to enable configuration and management of the security system wirelessly. The security system further comprises a gateway device and a wireless access point configured to communicate with one or more electronic devices and to monitor event data from one or more electronic devices. As used herein, the term “gateway device” refers to a device configured to operably couple to a network, for example, the internet, and also to couple wirelessly through the wireless access point to one or more electronic devices. The gateway device is configurable with one or more application programs to monitor and/or control one or more electronic devices via the wireless access point. Also, as used herein, the term “wireless access point” refers to a device that allows wireless electronic devices to connect to a network, for example, using Wi-Fi® of the Wireless Ethernet Compatibility Alliance, Inc. The wireless access point is incorporated in the gateway device. One or more electronic devices that monitor and capture event data on multiple events connect to the gateway device of the security system via the wireless access point. The electronic devices comprise, for example, wired or wireless surveillance sensors such as proximity sensors, contact sensors, passive infrared (PIR) motion sensors, audio sensors, water sensors, etc., monitoring devices, tracking devices, surveillance devices such as a Wi-Fi® enabled cameras, etc., a personal computer, a tablet computing device, a mobile computer, a mobile phone, a smart phone, a laptop, a personal digital assistant, a touch centric device, a workstation, a client device, a network enabled computing device, an interactive network enabled communication device, a gaming device, a set top box, a television, an image capture device, a web browser, a video recorder, an audio recorder, a global positioning system (GPS) device, any other suitable computing equipment, and combinations of multiple pieces of computing equipment, etc. The events comprise, for example, alarm trigger events, security system status change events, electronic device status change events, camera events such as motion triggered video recording, panic events, exception events such as unavailability of electronic devices, low battery, a low wireless signal warning, passcode change events for keypads and control panels, etc.

The gateway device is configured, for example, as a box, an alarm panel, or a separate internet gateway. The gateway device disclosed herein is also configured as an alarm panel gateway and/or a camera gateway. The alarm panel gateway is configured to support a universal serial bus (USB) modem, for example, a third generation (3G) modem, a fourth generation (4G) modem, etc. In an embodiment, the alarm panel gateway and the camera gateway incorporate an energy storage device as a battery backup to prevent failure of the security system due to unprecedented events, for example, a power failure, unauthorized disarming of the security system, etc. Furthermore, the alarm panel gateway and the camera gateway can be armed or disarmed jointly or individually. In an embodiment, the security system is implemented as an alarm system that incorporates a master gateway device to which different wired and wireless electronic devices connect. The master gateway device comprises a communication channel, for example, a phone line, a cellular network adaptor, the internet, etc. The master gateway device is configured to relay an alert to a central station, a user's control device, etc. As used herein, the term “user” refers to a person or an entity that is in possession of the control device for wirelessly configuring and controlling the security system. Also, as used herein, the term “control device” refers to an electronic device, for example, a key fob remote, a device having a secondary keypad, a mobile phone, an internet enabled mobile device, a personal computer, a tablet computing device, a mobile computer, a smart phone, a laptop, a personal digital assistant, a touch centric device, a workstation, a client device, a portable electronic device, a network enabled computing device, an interactive network enabled communication device, etc., used for wirelessly configuring and setting up the security system.

The combination of the gateway device and the wireless access point in the security system enables the security system to communicate and monitor event data from one or more electronic devices. As used herein, the term “event data” refers to computer readable data, for example, audiovisual data, snapshot data, video data, image data, data indicative of motion, etc., associated with events performed by an electronic device and/or an authorized user or an unauthorized user, for example, based on an action, a characteristic, a condition or a state, a state change, behavior, performance, etc., of the electronic device and/or the authorized user or the unauthorized user. The event data comprises, for example, an alert triggered by electronic devices such as wired or wireless surveillance sensors on detection of any unauthorized event, a change in status of the security system and/or one or more of the electronic devices, a motion triggered video recording or an image or picture recording by wired or wireless surveillance sensors, an alert triggered by pressing of a panic button provided on the electronic devices and/or the security system, unavailability of the electronic devices, a low battery indication, a low wireless signal indication, a change of a passcode of the security system, etc. As used herein, the term “unauthorized event” refers to any unauthorized intrusion into a premises, for example, a house, a shop, a building, etc., or a network path by an unauthorized user. The unauthorized event may also refer to any unauthorized intrusion by an unauthorized device attempting to access and control the security system.

A wireless router is operably connected 102 to the security system, for example, through a zero router configuration to establish a network. As used herein, the term “router” refers to a computer networking device that forwards data packets between the security system and the control device and the electronic devices based on a network and higher layer information. Also, as used herein, the term “zero router configuration” refers to an automatic configuration of the wireless router that does not require manual configuration of the wireless router by a user to establish and/or access the network. In an embodiment, the security system is embedded with a wireless router, for example, a Wi-Fi® router to create a router with a direct or zero router configuration. With the zero router configuration, the user does not need to configure the wireless router to allow access of the security system to the electronic devices and the user's control device, as opposed to a conventional gateway that requires the user to manually configure the wireless router to allow the user to establish and/or access the network, for example, by opening and/or forwarding ports, enabling universal plug and play (UPnP), configuring the wireless router to allow access externally to the gateway on a local network, etc.

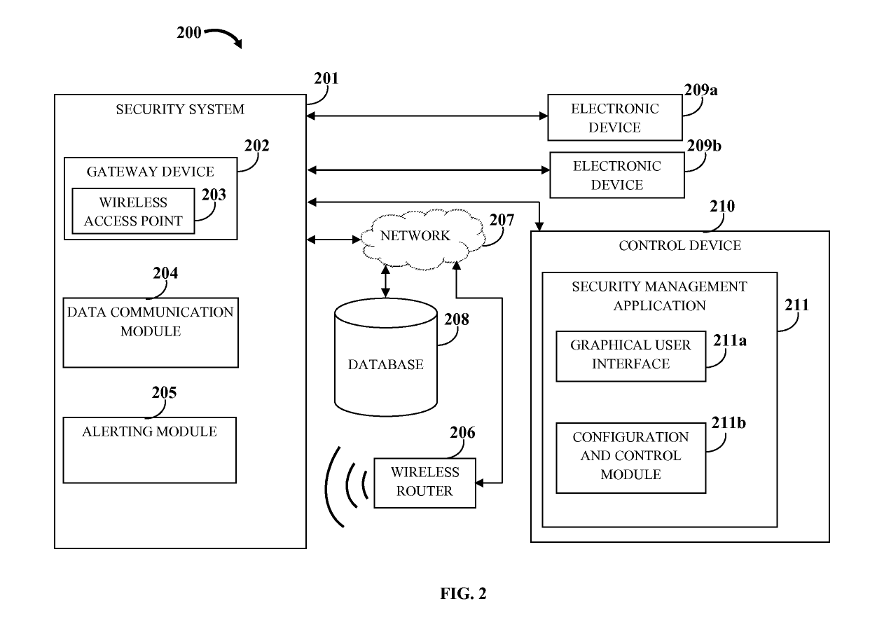

The wireless router comprises, for example, a master central processing unit (CPU), interfaces, and a bus such as a peripheral component interconnect (PCI) bus. While operating under the control of appropriate software or firmware, the CPU of the wireless router performs router tasks, for example, routing table computations, network management, and general processing of data packets. The CPU of the wireless router performs router functions under the control of software including an operating system and any appropriate application software. In an embodiment, the wireless router is externally connected to the security system as exemplarily illustrated in FIG. 2. In another embodiment, the wireless router is embedded in the gateway device of the security system, for example, using a cellular modem. The network established by the wireless router is, for example, a wireless network, a network that implements Wi-Fi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, etc., a local area communication network, an internet connection network, an infrared communication network, etc., or a network formed from a combination of these networks. The gateway device may contain devices such as protocol translators, impedance matching devices, rate converters, fault isolators, or signal translators for system interoperability. The gateway device is associated with the wireless router, which knows where to direct a packet of data that arrives at the gateway device, and a switch, which furnishes the actual path in and out of the gateway device for a given data packet. In an embodiment, the wireless access point connects to the wireless router, for example, via a wired network if the wireless access point is a standalone device. In another embodiment, the wireless access point is a part of the wireless router itself. The wireless access point is incorporated into the gateway device to access the electronic devices wirelessly.

The computer implemented method provides 103 a security management application executable by at least one processor on the user's control device. The security management application is configured to access, configure, and control the security system and one or more electronic devices wirelessly through the wireless access point of the security system. The security system receives 104 event data on one or more events from one or more electronic devices through the wireless access point. The security system is configured to transmit 105 the received event data to a database, the control device, and/or one or more secondary devices via the network.

In an embodiment, the security system detects an unauthorized event performed by an unauthorized user using the received event data. For example, when the security system receives event data, for example, a status change from a sensor due to an intrusion, the security system detects the unauthorized event and triggers an alert or an alarm. The security system further comprises an audio siren to sound an alarm on detection of the unauthorized event. In another embodiment, the security system prevents unauthorized electronic devices from accessing and controlling the security system. For example, the security system prevents unauthorized cameras or sensors attempting to access the security system. During registration with a server associated with the security system, a user can register electronic devices with the user's account maintained on the server. Each electronic device that is intended for connection to the security system is paired or security coded during registration of the electronic device with the server. The security system therefore recognizes registered electronic devices and precludes unauthorized electronic devices from connecting to the gateway device of the security system via the wireless access point. To setup the security system, the user requires physical access to the security system to enable a setup mode via a physical interface element such as a switch or a button on the security system to allow the wireless access point of the security system to be activated and to allow the user' control device to directly connect to the gateway device of the security system via the activated wireless access point. After the security system is setup, a server associated with the security system authenticates and authorizes the user's control device and the electronic devices to access the gateway device of the security system via the wireless access point. The security system detects encrypted data packets received but not authorized by the security system.

The security system generates an alert on detection of the unauthorized event. The security system transmits an alert message to the security management application on the control device via the network, when one or more of the electronic devices detect the unauthorized event. The security system transmits an alert message to the security management application on the control device, for example, via electronic mail (email), a short message service (SMS) message, a multimedia messaging service (MMS) message, etc. The security system implements a secure wireless communication protocol to prevent an intrusion from an external device or unauthorized access to the gateway device of the security system via the wireless access point that implements, for example, Wi-F′®. For example, the security system implements an industry level 128-bit secure sockets layer (SSL) to encrypt video transmission channels to protect video data from the video transmission channels end-to-end from the electronic device to the user's control device. The computer implemented method disclosed herein does not expose the event data to the public domain, for example, to the public internet. The computer implemented method disclosed herein protects the event data behind a local network firewall and hides the event data from the public internet.

In an embodiment, the security system transmits one or more notifications on status and actions triggered in the security system to the security management application on the control device via the network, for example, when an alert or an alarm is triggered, when the status of an electronic device or the security system changes, when the security system is armed or disarmed, when there is an exception such as unavailability of an electronic device to the gateway device of the security system, when a panic button is pressed, when there is motion detected video or snapshots recording, when there is an electronic device status change and the security system is not armed, etc. The security system also periodically transmits a low battery notification to the security management application on the control device via the network, if any of the electronic devices has a low battery charge. In an embodiment, the server associated with the security system filters and transmits the notifications periodically to the security management application on the control device via the network. For example, the server transmits a warning to the security management application on the control device via the network when the battery charge is at 10% and transmits another warning when the battery charge is at 5%.

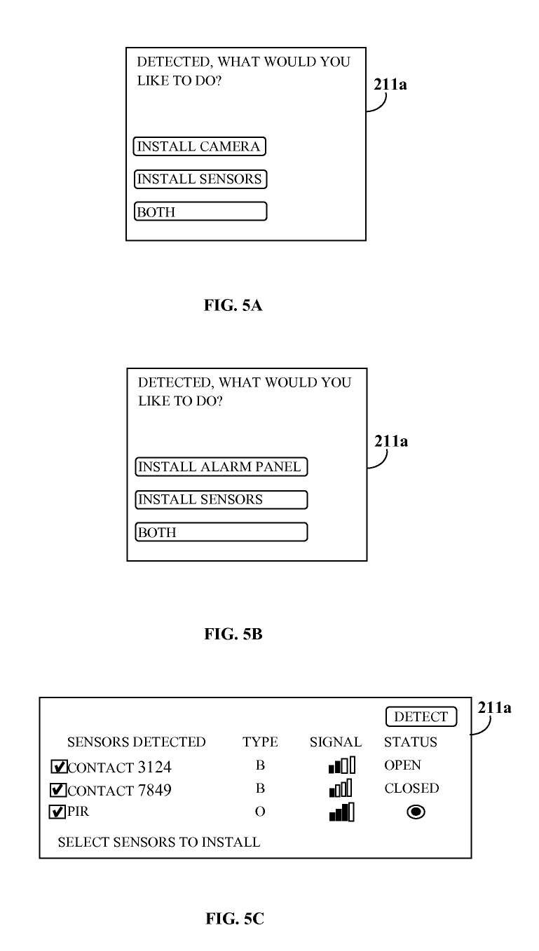

The security management application on the control device wirelessly configures and manages 106 the security system and one or more of the electronic devices through the wireless access point via the network based on the received event data. The security management application on the control device guides a user to successfully set up the entire security system step by step as disclosed in the detailed description of FIGS. 5A-5C. In an embodiment, the security management application on the control device provides a graphical user interface (GUI) for receiving, for example, selections of one or more of the electronic devices, definitions of security profiles and zones, user inputs from the control device, etc., for the configuration and the management of the security system and one or more of the electronic devices. The user may select the electronic devices that are allowed to access the gateway device of the security system via the wireless access point using the GUI of the security management application. The user may also define virtual alarm profiles and virtual zones in an area or tie up across physical gateways using the GUI of the security management application.

In an embodiment, the security management application on the control device activates or deactivates the security system through the wireless access point. For example, a user can arm or disarm the security system through the wireless access point using the security management application on the control device. The user may deactivate the security system and instruct the security system to sound the alarm via the audio siren or transmit a notification to security personnel, via the security management application on the control device. In another embodiment, the security management application on the control device changes security settings of the security system through the wireless access point. For example, a user can wirelessly change a passcode and a security setting of the security system through the wireless access point using the GUI of the security management application on the control device.

The user can arm and/or disarm the security system using profiles configured in the security management application of the control device. The profiles comprise, for example, an arm home profile and an arm away profile. As used herein, the term “arm home profile” refers to a profile set on the security system for arming the security system, when users are present at a premises. Also, as used herein, the term “arm away profile” refers to a profile set on the security system for arming the security system when users are not present in a predefined area. The arm home profile arms the security system by activating some electronic devices, for example, the proximity sensors, the contact sensors, the audio sensors, the water sensors, etc. In an embodiment, the passive infrared (PIR) motion sensors are disabled in the arm home profile. If the security system is armed in the arm home profile, on detection of an unauthorized event by one or more of the electronic devices, the security system generates an alert message and transmits an instruction to the audio siren to sound an alarm. The arm away profile arms the security system by activating all the electronic devices including the PIR motion sensors. When the security system is set to the arm away profile and one or more of the electronic devices of the security system are activated, a countdown is initiated prior to the arming of the security system. The countdown is configured to time an entry delay to the predefined area and/or an exit delay to the predefined area. If the security system is not disarmed before the expiry of the countdown, the audio siren sounds the alarm.

In an embodiment, when one or more of the electronic devices are not responding or are not ready for arming, the security management application displays a list of unresponsive electronic devices on the user's control device via the GUI and requests the user whether he/she wants to bypass the unresponsive electronic devices. The user can then choose to bypass activation of the unresponsive electronic devices or wait for activation of the unresponsive electronic devices. The security system is armed on activation of any one of the electronic devices. When the user selects the bypass option in the security management application on the user's control device, the countdown is initiated, thereby arming the security system. The bypassed electronic devices cannot trigger alerts if they are activated after the arming of the security system. In an embodiment, the security management application transmits a notification to the user's control device, for example, via electronic mail (email), a short message service (SMS) message, a multimedia messaging service (MMS) message, etc., on receiving an alert message from the security system on detection of the unauthorized event by one or more of the electronic devices.

When the user logs in to the security management application on the control device via the GUI, a login screen on the GUI displays the status of the security system as armed and provides a disarm option to disarm the security system. The user can select the disarm option to disarm the security system. In an embodiment, the security management application maintains a track of the bypassed electronic devices at the time of arming and/or disarming the security system. In an embodiment, if the security system is armed and/or disarmed using an external device, for example, a key fob remote, a control panel, a key pad, etc., the security system transmits a notification on the status of the security system to the user's control device in use, for example, via electronic mail (email), a short message service (SMS) message, a multimedia messaging service (MMS) message, etc. The security system also transmits notifications to the security management application on the user's control device when any of the authorized users access the security system and/or make any changes to the security system and/or the electronic devices associated with the security system.

In an embodiment, the computer implemented method disclosed herein provides multiple options to the user based on a type of membership opted by the user during registration. For example, the user can maintain a multiple user notification list in the database to notify selected users, for example, neighbors, security personnel, etc., in cases of a security breach. The security system also maintains an activity log report of the electronic devices in the database, where the activity log report comprises historical data of the electronic devices. The security management application on the user's control device retrieves the activity log report of the electronic devices comprising information about activities of the electronic devices since the electronic devices were installed in the security system from the database via the network.

The security management application allows the user to define profiles, for example, a virtual alarm profile and a virtual zone to facilitate viewing and/or configuration of the electronic devices. As used herein, the term “virtual alarm profile” refers to a profile created for each of the electronic devices for configuring, enabling, and disabling each of the electronic devices. The virtual alarm profile displays various attributes of each of the electronic devices, for example, battery status, wireless signal strength, current activation status, performance efficiency, etc. Also, as used herein, the term “virtual zone” refers to a zone of access defined by the security system and each of the electronic devices in a predefined area. The security management application provides a configure interface element, for example, a button, an icon, etc., on the graphical user interface (GUI) of the security management application to configure the virtual zone. By clicking on the configure interface element, the user can configure the virtual zone, for example, by configuring an entry delay, an exit delay, notification settings, etc. The user can configure each of the electronic devices associated with each virtual zone via the GUI. For example, the user can view each of the electronic devices in a first zone via the GUI and configure attributes such as battery status, wireless signal strength, current activation status, performance efficiency, etc., of each of the electronic devices in the first zone. The user can also trigger a test operation on each of the electronic devices in each virtual zone via the GUI. In an embodiment, the user can sort the electronic devices based on the virtual alarm profiles and/or the virtual zones via the GUI.

In an embodiment, the security system, in communication with the security management application on the user's control device, performs anomaly detection. The security system transmits a notification to the security management application on the GUI on detection of any irregularities in the performance of the electronic devices. The computer implemented method disclosed herein also enables automatic configuration of the security system based on settings configured by the user using the security management application on the user's control device. For example, the security management application facilitates automatic installation and uninstallation of the security system and/or the electronic devices based on a heuristic analysis performed by the security management application. The heuristic analysis is performed by the security management application on multiple factors associated with the security system and the electronic devices, for example, location of the security system, schedule of the activities of the security system and the electronic devices, log history of the activities of the electronic devices, etc.

FIG. 2 illustrates a computer implemented system 200 for configuring and managing a security system 201 wirelessly. The computer implemented system 200 disclosed herein comprises the wireless router 206, the security system 201, and the security management application 211 provided on a user's control device 210. The wireless router 206 is operably connected to the security system 201 to establish the network 207. The security system 201 comprises at least one processor and a non-transitory computer readable storage medium communicatively coupled to the processor. The processor executes modules, for example, 204, 205, etc., of the security system 201. The non-transitory computer readable storage medium is configured to store the modules, for example, 204, 205, etc., of the security system 201. The security system 201 further comprises the wireless access point 203, the gateway device 202, a data communication module 204, and an alerting module 205. In an embodiment, the security system 201 is implemented in the form of a box having a security panel, the wireless router 206, and the gateway device 202. In another embodiment, the modules, for example, 202, 203, 204, and 205 of the security system 201 are implemented in separate functional boxes interlinked to each other to transfer required data among them.

The wireless access point 203 is incorporated in the gateway device 202. The wireless access point 203 connects the electronic devices 209a and 209b to the gateway device 202 wirelessly. The electronic devices 209a and 209b, for example, wireless surveillance sensors and devices connect to the gateway device 202 of the security system 201 wirelessly through the wireless access point 203. The control device 210, for example, an internet enabled device such as a tablet computer connects or links directly to the gateway device 202 of the security system 201 wirelessly through the wireless access point 203 to program and set up operation of the security system 201. The gateway device 202 communicates with one or more electronic devices 209a and 209b and the control device 210 and monitors event data, for example, audiovisual data, snapshot data, video data, image data, etc., associated with multiple events from one or more electronic devices 209a and 209b. In an embodiment, the gateway device 202 in the security system 201 resides with the wireless router 206.

The data communication module 204 of the security system 201 receives event data on one or more events from the electronic devices 209a and 209b through the wireless access point 203. The computer implemented system 200 disclosed herein further comprises a database 208. In an embodiment, the database 208 is a cloud database that runs on a cloud computing platform, for example, PC Backup™ of MyPCBackup, Ltd., Amazon EC2 of Amazon Technologies Inc., GoGrid® of GoGrid, LLC, the Rackspace® cloud of Rackspace US, Inc., etc. The data communication module 204 transmits the received event data to the database 208, the control device 210, and/or one or more secondary devices (not shown) via the network 207. The secondary devices comprise, for example, other devices registered by the user for receiving notifications, alerts, etc. The database 208 stores the event data on the events received from the security system 201 via the network 207. In an embodiment, the security management application 211 on the control device 210 accesses the stored event data from the database 208 via the network 207.

In an embodiment, the alerting module 205 of the security system 201 detects an unauthorized event performed by an unauthorized user or an unauthorized electronic device using the received event data and generates an alert on detection of the unauthorized event. The alerting module 205 also generates an alert and transmits an alert message to the security management application 211 on the control device 210 via the network 207, when one or more of the electronic devices 209a and 209b detect an unauthorized event. The alerting module 205 transmits one or more notifications on status and actions triggered in the security system 201 to the security management application 211 on the control device 210 via the network 207.

The security management application 211 is executable by at least one processor on the control device 210. The security management application 211 comprises a graphical user interface (GUI) 211a and a configuration and control module 211b. The GUI 211a receives, for example, selections of one or more of the electronic devices 209a, 209b, etc., definitions of security profiles and zones, user inputs, etc., from the control device 210 for the configuration and the management of the security system 201 and one or more of the electronic devices 209a, 209b, etc. The configuration and control module 211b accesses the security system 201 via the GUI 211a and configures, controls, and manages the security system 201 and one or more of the electronic devices 209a, 209b, etc., wirelessly through the wireless access point 203 of the security system 201 via the network 207 based on the received event data. In an embodiment, the configuration and control module 211b activates and deactivates the security system 201 through the wireless access point 203. In another embodiment, the configuration and control module 211b changes security settings of the security system 201 through the wireless access point 203 based on the user's preferences.

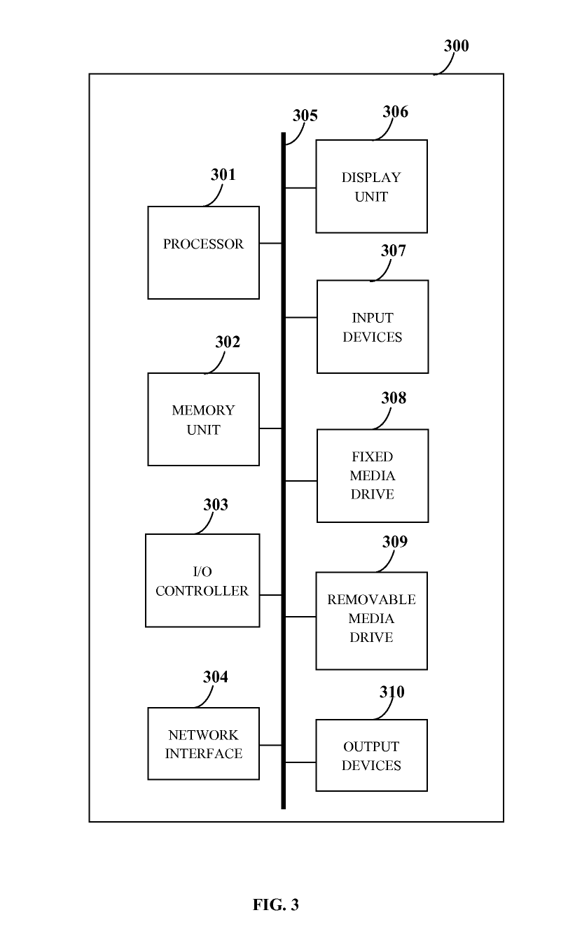

FIG. 3 exemplarily illustrates an architecture of a computer system 300 employed by the security system 201 and the security management application 211 for configuring and managing the security system 201 wirelessly. The security system 201 and the security management application 211 of the computer implemented system 200 exemplarily illustrated in FIG. 2 employ the architecture of the computer system 300 exemplarily illustrated in FIG. 3. The computer system 300 is programmable using a high level computer programming language. The computer system 300 may be implemented using programmed and purposeful hardware. The security system 201 communicates with the security management application 211 on the control device 210 via the network 207, for example, a short range network or a long range network. The network 207 is, for example, the internet, a local area network, a wide area network, a wireless network, a mobile communication network, etc. The computer system 300 comprises, for example, a processor 301, a memory unit 302 for storing programs and data, an input/output (I/O) controller 303, a network interface 304, a data bus 305, a display unit 306, input devices 307, a fixed media drive 308, a removable media drive 309 for receiving removable media, output devices 310, etc.

The term “processor” refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 301 may also be implemented as a processor set comprising, for example, a general purpose microprocessor and a math or graphics co-processor. The processor 301 is selected, for example, from the Intel® processors such as the Itanium® microprocessor or the Pentium® processors, Advanced Micro Devices (AMD®) processors such as the Athlon® processor, UltraSPARC® processors, microSPARC™ processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, etc. The computer implemented system 200 disclosed herein is not limited to a computer system 300 employing a processor 301. The computer system 300 may also employ a controller or a microcontroller.

The memory unit 302 is used for storing programs, applications, and data. For example, the data communication module 204 and the alerting module 205 of the security system 201 are stored in the memory unit 302 of the security system 201. In another example, the configuration and control module 211b of the security management application 211 is stored in the memory unit 302 of the control device 210. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301.

The network interface 304 enables connection of the computer system 300 to the network 207. For example, the security system 201 connects to the network 207 via the network interface 304. In an embodiment, the network interface 304 is provided as an interface card also referred to as a line card. The network interface 304 comprises, for example, one or more of an infrared (IR) interface, an interface implementing Wi-Fi® of the Wireless Ethernet Compatibility Alliance, Inc., a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The I/O controller 303 controls input actions and output actions performed by the security system 201. The data bus 305 of the security system 201 permits communications between the modules, for example, 204 and 205 of the security system 201. The data bus 305 of the control device 210 permits communications between the modules 211a and 211b of the security management application 211.

The display unit 306, via the graphical user interface (GUI) 211a of the security management application 211, displays information, display interfaces, user interface elements such as text fields, checkboxes, text boxes, images, windows, videos, etc., for example, for displaying captured and monitored videos, events, etc. The display unit 306 comprises, for example, a liquid crystal display, a plasma display, an organic light emitting diode (OLED) based display, etc. The input devices 307 are used for inputting data into the computer system 300. For example, the user enters the security settings for the security system 201, the selections of the electronic devices 209a, 209b, etc., into the GUI 211a of the security management application 211 using the input devices 307 of the control device 210. The input devices 307 are, for example, a keyboard such as an alphanumeric keyboard, a microphone for providing voice input, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the computer system 300. The programs are loaded onto the fixed media drive 308 and into the memory unit 302 of the computer system 300 via the removable media drive 309. In an embodiment, the computer applications and programs may be loaded directly via the network 207. Computer applications and programs are executed by double clicking a related icon displayed on the display unit 306 using one of the input devices 307. The output devices 310 output the results of operations performed by the security system 201 and the security management application 211. For example, the security management application 211 displays the captured event data on the GUI 211a of the security management application 211 using the output devices 310 of the control device 210.

The processor 301 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, Windows Phone™ operating system of Microsoft Corporation, BlackBerry® operating system of Research in Motion Limited, the iOS operating system of Apple Inc., the Symbian® operating system of Symbian Foundation Limited, etc. The computer system 300 employs the operating system for performing multiple tasks. The operating system is responsible for management and coordination of activities and sharing of resources of the computer system 300. The operating system further manages security of the computer system 300, peripheral devices connected to the computer system 300, and network connections. The operating system employed on the computer system 300 recognizes, for example, inputs provided by the users using one of the input devices 307, the output display, files, and directories stored locally on the fixed media drive 308, for example, a hard drive. The operating system on the computer system 300 executes different programs using the processor 301. The processor 301 and the operating system together define a computer platform for which application programs in high level programming languages are written.

The processor 301 of the security system 201 retrieves instructions for executing the modules, for example, 204 and 205 of the security system 201 from the memory unit 302 of the security system 201. The processor 301 of the control device 210 retrieves instructions for executing the configuration and control module 211b of the security management application 211 from the memory unit 302 of the control device 210. A program counter determines the location of each of the instructions in the memory unit 302. The program counter stores a number that identifies the current position in the program of each of the modules, for example, 204 and 205 of the security system 201 and the configuration and control module 211b of the security management application 211. The instructions fetched by the processor 301 from the memory unit 302 after being processed are decoded. The instructions are stored in an instruction register in the processor 301. After processing and decoding, the processor 301 executes the instructions. For example, the data communication module 204 of the security system 201 defines instructions for receiving the event data on one or more events from one or more electronic devices 209a and 209b through the wireless access point 203. The data communication module 204 further defines instructions for transmitting the received event data to the database 208, the control device 210, and/or one or more secondary devices via the network 207. The alerting module 205 defines instructions for detecting an unauthorized event performed by unauthorized electronic devices using the received event data and for generating an alert on detection of the unauthorized event. The alerting module 205 further defines instructions for generating an alert and for transmitting an alert message to the security management application 211 on the control device 210 via the network 207 on detection of an unauthorized event by one or more of the electronic devices 209a and 209b. The alerting module 205 also defines instructions for transmitting one or more notifications on status and actions triggered in the security system 201 to the security management application 211 on the control device 210 via the network 207.

The configuration and control module 211b of the security management application 211 on the control device 210 defines instructions for accessing, configuring, controlling, and managing the security system 201 wirelessly through the wireless access point 203 of the security system 201 via the network 207 based on the received event data. The configuration and control module 211b further defines instructions for activating and deactivating the security system 201 through the wireless access point 203. The configuration and control module 211b further defines instructions for changing security settings of the security system 201 through the wireless access point 203 based on the user's preferences.

The processor 301 of the computer system 300 employed by the security system 201 retrieves the instructions defined by the data communication module 204 and the alerting module 205 and executes the instructions, thereby performing one or more processes defined by those instructions. The processor 301 of the computer system 300 employed by the control device 210 retrieves the instructions defined by the configuration and control module 211b and executes the instructions, thereby performing one or more processes defined by those instructions.

At the time of execution, the instructions stored in the instruction register are examined to determine the operations to be performed. The processor 301 then performs the specified operations. The operations comprise arithmetic operations and logic operations. The operating system performs multiple routines for performing a number of tasks required to assign the input devices 307, the output devices 310, and memory for execution of the modules, for example, 204 and 205 of the security system 201 and the configuration and control module 211b of the security management application 211. The tasks performed by the operating system comprise, for example, assigning memory to the modules, for example, 204 and 205 of the security system 201 and the configuration and control module 211b of the security management application 211, and to data used by the security system 201 and the security management application 211, moving data between the memory unit 302 and disk units, and handling input/output operations. The operating system performs the tasks on request by the operations and after performing the tasks, the operating system transfers the execution control back to the processor 301. The processor 301 continues the execution to obtain one or more outputs. The outputs of the execution of the modules, for example, 204 and 205 of the security system 201 and the configuration and control module 211b of the security management application 211 are displayed to the user on the display unit 306.

For purposes of illustration, the detailed description refers to each of the security system 201 and the security management application 211 being run locally on a computer system 300; however the scope of the computer implemented method and system 200 disclosed herein is not limited to the security system 201 and the security management application 211 each being run locally on the computer system 300 via the operating system and the processor 301, but may be extended to run remotely over the network 207 by employing a web browser and a remote server, a mobile phone, or other computing devices. One or more portions of the computer system 300 may be distributed across one or more computer systems (not shown) coupled to the network 207.

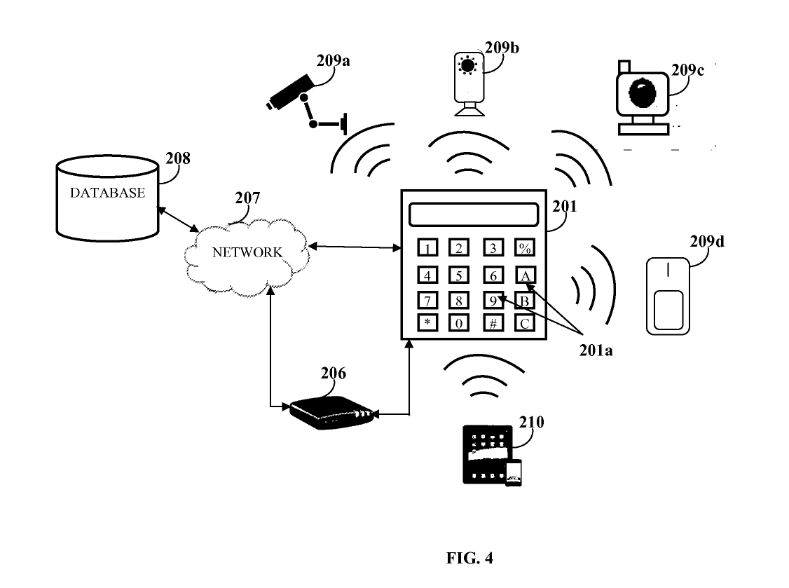

FIG. 4 exemplarily illustrates an implementation of the security system 201. Consider an example for configuring and managing the security system 201 wirelessly. The security system 201 is configured as an alarm panel with control buttons 201a as exemplarily illustrated in FIG. 4. The security system 201 is installed in a room. The wireless router 206 is operably connected to the security system 201 to establish the network 207. The security system 201 communicates with the database 208 implemented, for example, in a cloud computing environment. As used herein, the term “cloud computing environment” refers to a processing environment comprising configurable computing physical and logical resources, for example, networks, servers, storage, applications, services, etc., and data distributed over a network 207, for example, the internet. The cloud computing environment provides on-demand network access to a shared pool of the configurable computing physical and logical resources. A user invokes the security management application 211 on his/her control device 210, for example, a tablet computer and connects the security management application 211 wirelessly to the gateway device 202 of the security system 201 via the wireless access point 203 of the security system 201 as exemplarily illustrated in FIG. 2. The user configures security settings for the security system 201 via the graphical user interface (GUI) 211a of the security management application 211 to complete installation of the security system 201.

Electronic devices, for example, a surveillance device 209a, a camera 209b, a webcam 209c, and a sensor 209d positioned in the room connect wirelessly to the gateway device 202 of the security system 201 via the wireless access point 203 of the security system 201. The security system 201 receives event data, for example, video data from the surveillance device 209a, the camera 209b, and the webcam 209c, and sensor data such as motion information, temperature, pressure, etc., from the sensor 209d in the room and stores the event data in the database 208 via the network 207. The security management application 211 on the control device 210 accesses the event data from the database 208 via the network 207. In an embodiment, the security system 201 transmits the captured event data to the control device 210 via the network 207. The security system 201 monitors the room continuously and generates an alert when an unauthorized event or an unauthorized electronic device, for example, 209a, 209b, or 209c intrudes the network 207. On detection of the unauthorized event or an unauthorized electronic device, for example, 209a, 209b, or 209c, the security system 201 transmits an alert message to the security management application 211 on the control device 210 via the network 207. The user may then deactivate the security system 201 and instruct the security system 201 to sound an alarm via an audio siren or transmit a notification to security personnel via the GUI 211a of the security management application 211 on the control device 210.

FIGS. 5A-5C exemplarily illustrate screenshots of a graphical user interface (GUI) 211a provided by the security management application 211 exemplarily illustrated in FIG. 2, for configuring and managing the security system 201 wirelessly. Consider an example where a user wishes to install the security system 201 in his/her home premises and wirelessly arm and/or disarm the security system 201 via the security management application 211 provided in the user's control device 210, for example, a smart phone. The components of the security system 201 to be installed in the home premises comprises the gateway device 202 such as an alarm gateway device with a battery backup and an camera gateway device with a battery backup, electronic devices, for example, contact sensors, PIR motion sensors, audio sensors, and water sensors, a key fob remote, a secondary keypad, etc., for remotely arming and/or disarming the security system 201, an audio siren to sound an alarm, and a Wi-Fi® camera. The user connects the backup battery in the alarm gateway device and/or the camera gateway device. The user connects the camera gateway device to a power source. The user activates a Wi-Fi® setup button on the user's control device 210 and allows the user's control device 210 to establish a Wi-Fi® connection to the network 207 established by the wireless router 206 exemplarily illustrated in FIG. 2 and FIG. 4. The user's control device 210 further connects to the gateway device 202 of the security system 201 wirelessly via the wireless access point 203 of the security system 201 exemplarily illustrated in FIG. 2. The user then launches the security management application 211 in the control device 210.

The user registers with and logs in to the security management application 211 via the graphical user interface (GUI) 211a. The security management application 211 automatically detects the type of gateway device 202, for example, an alarm gateway device or a camera gateway device installed in the security system 201, the electronic devices such as sensors, etc., and prompts the user with further steps of installation of the security system 201 on the GUI 211a. FIG. 5A exemplarily illustrates an installation screen for the camera gateway device displayed on the GUI 211a. The security management application 211 prompts the user to select from options, for example, “install camera”, “install sensors”, and “both” as exemplarily illustrated in FIG. 5A. The user can select one of the options to configure a setup for the security system 201 based on the user's preferences. For example, if the user selects the “install camera” option, the security management application 211 prompts the user to setup the network 207, for example, a Wi-Fi® network. Thereafter, the security management application 211 prompts the user to setup a user account and a security passcode for the camera gateway device via the GUI 211a. In an embodiment, the user can define a name and a description for the camera gateway device setup via the GUI 211a.

FIG. 5B exemplarily illustrates an installation screen for the alarm gateway device displayed on the GUI 211a. The security management application 211 prompts the user to select from options, for example, “install alarm panel”, “install sensors”, and “both” as exemplarily illustrated in FIG. 5B. The user can select one of the options to configure a setup for the security system 201 based on the user's preferences. For example, if the user selects the “install alarm panel” option, the security management application 211 prompts the user to setup the network 207, for example, a Wi-Fi® network. Thereafter, the security management application 211 prompts the user to setup a user account and a security passcode for the alarm gateway device. The user can define a name and a description for the alarm gateway device setup via the GUI 211a. In another embodiment, the user can edit the existing key and security passcode via the GUI 211a.

FIG. 5C exemplarily illustrates a device installation screen for the electronic devices displayed on the GUI 211a. The user may install the electronic devices, for example, the wired or wireless surveillance sensors such as proximity sensors, contact sensors, passive infrared (PIR) motion sensors, audio sensors, water sensors, etc., by selecting the “install sensors” option and/or the “both” option exemplarily illustrated in FIGS. 5A-5B. After selecting the “install alarm panel” option on the installation screen exemplarily illustrated in FIG. 5B, the user can install the electronic devices by clicking on an “install alarm components” option on the GUI 211a. The security management application 211 displays a splash page that instructs the user to remove a covering on each of the electronic devices and/or insert a battery in each of the electronic devices. The device installation screen displays a “detect” button on the GUI 211a to allow the user to initiate wireless detection and installation of the electronic devices. On clicking the detect button on the GUI 211a, the device installation screen displays a list of the detected electronic devices on the GUI 211a as exemplarily illustrated in FIG. 5C. The device installation screen displays information of the available electronic devices, for example, names of the electronic devices, types of the electronic devices, signal strengths of the electronic devices, an activation status of each of the electronic devices, etc. If any of the available electronic devices is not displayed in the list, the user can click on the “detect” button to redetect the available electronic devices. The user can edit the names of the electronic devices displayed in the list via the GUI 211a. In an embodiment, the user can define color coded icons to indicate the activation status of each of the electronic devices to be displayed in the list. The user can define, for example, a green color coded icon and/or a text message, for example, “OK” to indicate an activation status of a detected electronic device, a yellow color coded icon and/or a text message, for example, “Open” to indicate an available status of an available electronic device, etc., as exemplarily illustrated in FIG. 5C.

In an embodiment, the security management application 211 updates the activation status of the electronic devices in real time to enable the user to install and/or uninstall any of the electronic devices in real time. The user can use the activation status to determine which sensor he/she is installing by manually changing the status of the sensor, that is, by opening or closing a contact sensor. The user can select and/or deselect one or more of the available electronic devices from the list. The selected electronic devices have indication boxes comprising an indication icon, for example, a check mark, an arrow, etc., displayed next to the names of the electronic devices as exemplarily illustrated in FIG. 5C. The user can uninstall the installed electronic devices by removing the indication icon, for example, the check mark from the indication box. Before uninstalling the installed electronic devices, the security management application 211 prompts the user with a message to confirm uninstallation, for example, “Are you sure you want to uninstall?” to avoid inadvertent uninstallation of any of the installed electronic devices. After the user confirms the uninstallation of an electronic device, the security management application 211 deletes the electronic device from the user's account. After the electronic devices are installed and/or uninstalled successfully, the GUI 211a of the security management application 211 displays a finish page confirming installation and/or uninstallation of the electronic devices. The user can then deactivate or turn off the Wi-Fi® setup mode and use the security system 201 with all the installed electronic devices enabled.

It will be readily apparent that the various methods, algorithms, and computer programs disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Other object-oriented, functional, scripting, and/or logical programming languages may also be used. The computer program codes or software programs may be stored on or in one or more mediums as object code. Various aspects of the computer implemented method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

Where databases are described such as the database 208, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices may comprise processors, for example, the Intel® processors, Advanced Micro Devices (AMD®) processors, UltraSPARC® processors, hp® processors, International Business Machines (IBM®) processors, RISC based computer processors of ARM Holdings, Motorola® processors, etc., that are adapted to communicate with the computers. In an embodiment, each of the computers is equipped with a network communication device, for example, a network interface card, a modem, or other network connection device suitable for connecting to a network. Each of the computers and the devices executes an operating system, for example, the Linux® operating system, the Unix® operating system, any version of the Microsoft® Windows® operating system, the Mac OS of Apple Inc., the IBM® OS/2, the Palm OS®, the Solaris operating system developed by Sun Microsystems, Inc., or any other operating system. Handheld devices execute operating systems, for example, the Android operating system, the Windows Phone™ operating system of Microsoft Corporation, the BlackBerry® operating system of Research in Motion Limited, the iOS operating system of Apple Inc., the Symbian® operating system of Symbian Foundation Limited, etc. While the operating system may differ depending on the type of computer, the operating system will continue to provide the appropriate communications protocols to establish communication links with the network. Any number and type of machines may be in communication with the computers.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for configuring and managing a security system wirelessly, comprising:
providing said security system comprising at least one processor configured to enable said configuration and said management of said security system wirelessly, said security system further comprising a gateway device and a wireless access point configured to communicate with one or more of a plurality of electronic devices and to monitor event data from said one or more of said electronic devices, wherein said wireless access point is incorporated in said gateway device, and wherein said one or more of said electronic devices connect to said gateway device of said security system via said wireless access point;
operably connecting a wireless router to said security system to establish a network;
providing a security management application executable by at least one processor on a control device, said security management application configured to access, configure, and control said security system and said one or more of said electronic devices wirelessly through said wireless access point;
receiving said event data on one or more of a plurality of events from said one or more of said electronic devices by said security system through said wireless access point, wherein said security system is configured to transmit said received event data to one or more of a database, said control device, and one or more secondary devices via said network; and
wirelessly configuring and managing said security system and said one or more of said electronic devices by said security management application on said control device through said wireless access point via said network based on said received event data.

2. The computer implemented method of claim 1, further comprising:
detecting an unauthorized event performed by an unauthorized one or more of said electronic devices by said security system using said received event data; and
generating an alert by said security system on said detection of said unauthorized event.

3. The computer implemented method of claim 1, further comprising generating an alert by said security system and transmitting an alert message by said security system to said security management application on said control device via said network, on detection of an unauthorized event by said one or more of said electronic devices.

4. The computer implemented method of claim 1, further comprising transmitting one or more notifications on status and actions triggered in said security system by said security system to said security management application on said control device via said network.

5. The computer implemented method of claim 1, further comprising providing a graphical user interface by said security management application on said control device, wherein said graphical user interface is configured to receive selections of one or more of said electronic devices, definitions of security profiles and zones, and user inputs from said control device for said configuration and said management of said security system and said one or more of said electronic devices.

6. The computer implemented method of claim 1, further comprising one of activating and deactivating said security system by said security management application on said control device through said wireless access point.

7. The computer implemented method of claim 1, further comprising changing security settings of said security system by said security management application on said control device through said wireless access point.

8. A computer implemented system for configuring and managing a security system wirelessly, comprising:
said security system comprising:
at least one processor configured to execute modules of said security system;
a non-transitory computer readable storage medium communicatively coupled to said at least one processor, said non-transitory computer readable storage medium configured to store said modules of said security system;
a gateway device configured to communicate with one or more of a plurality of electronic devices and monitor event data from said one or more of said electronic devices; and
a wireless access point configured to connect said one or more of said electronic devices to said gateway device, wherein said wireless access point is incorporated in said gateway device;
a wireless router operably connected to said security system to establish a network;
said modules of said security system comprising a data communication module configured to receive said event data on one or more of a plurality of events from said one or more of said electronic devices through said wireless access point, wherein said data communication module is configured to transmit said received event data to one or more of a database, a control device, and one or more secondary devices via said network; and
a security management application executable by at least one processor on said control device, said security management application comprising a configuration and control module configured to access, configure, control, and manage said security system and said one or more of said electronic devices wirelessly through said wireless access point via said network based on said received event data.

9. The computer implemented system of claim 8, wherein said modules of said security system further comprise an alerting module configured to detect an unauthorized event performed by an unauthorized one or more of said electronic devices using said received event data, wherein said alerting module is further configured to generate an alert on said detection of said unauthorized event.

10. The computer implemented system of claim 8, wherein said modules of said security system further comprise an alerting module configured to generate an alert and transmit an alert message to said security management application on said control device via said network, on detection of an unauthorized event by said one or more of said electronic devices.

11. The computer implemented system of claim 10, wherein said alerting module is further configured to transmit one or more notifications on status and actions triggered in said security system to said security management application on said control device via said network.

12. The computer implemented system of claim 8, wherein said security management application further comprises a graphical user interface configured to receive selections of one or more of said electronic devices, definitions of security profiles and zones, and user inputs from said control device for said configuration and said management of said security system and said one or more of said electronic devices.

13. The computer implemented system of claim 8, wherein said configuration and control module of said security management application on said control device is further configured to one of activate and deactivate said security system through said wireless access point.

14. The computer implemented system of claim 8, wherein said configuration and control module of said security management application on said control device is further configured to change security settings of said security system through said wireless access point.

15. The computer implemented system of claim 8, further comprising said database configured to store said event data on said one or more of said events received from said security system via said network.
